(19) United States
(12) Patent Application Publication
(10) Pub. No.: US 2024/0423862 A1
(43) Pub. Date: Dec. 26, 2024

(54) MASSAGE APPARATUS FOR PULLING WAIST

(71) Applicant: BODYFRIEND CO., LTD., Seoul (KR)

(72) Inventors: Sung Gu LIM, Seoul (KR); Deok Hyun KONG, Seoul (KR); Myeong Jin YOU, Seoul (KR)

(21) Appl. No.: 18/703,670

(22) PCT Filed: Oct. 24, 2022
(86) PCT No.: PCT/KR2022/016293

§ 371 Date: Apr. 22, 2024

(30) Foreign Application Priority Data
Oct. 22, 2021 (KR) 10-2021-0141762
Jan. 20, 2022 (KR) 10-2022-0008173
Jan. 20, 2022 (KR) 10-2022-0008580

(51) Int. Cl. A61H 1/02; A61H 7/00; A61H 15/00; A61H 23/00; A61H 39/04

(52) U.S. Cl. CPC A61H 1/0229; A61H 7/007; A61H 15/0078; A61H 23/006; A61H 39/04; A61H 2015/0014; A61H 2015/0042; A61H 2201/0107; A61H 2201/0149; A61H 2201/0192; A61H 2201/1238; A61H 2201/14; A61H 2201/1616; A61H 2201/1626; A61H 2201/1633; A61H 2201/1642; A61H 2201/1664; A61H 2201/5002; A61H 2201/5048; A61H 2203/0437; A61H 2205/062; A61H 2205/088; A61H 2205/106; A61H 2205/12

(57) ABSTRACT

The present invention relates to a method for operating a massage apparatus for pulling a user's waist, the method comprising: a step in which a control unit controls a back frame so that the back frame reclines backward; a step in which the control unit controls a leg massage part so that the leg massage part is lifted up; a step in which the position of a massage module is controlled so that a massage ball is positioned on the user's waist; and a step in which the massage ball is moved in a first direction or a second direction and air is injected into a waist airbag to pull the user's waist.

### TECHNICAL FIELD

The present disclosure relates to a massage apparatus for pulling a waist and a method of operating the same.

### BACKGROUND ART

Massage or rub-down is a medical supplementary therapy that corrects a posture of a subject, helps blood circulation, and relieves a fatigue of a subject by applying various types of mechanical stimulations to parts of a body, such as kneading, pressing, pulling, tapping, or moving parts of the subject's body.

The increase in demand for the massage causes an increase in demand for massage apparatuses or massage devices that provide an artificial massage function due to economic and time reasons. In other words, as a demand for relieving fatigue or stress by relaxing tense muscles through the massage increases, various time- and cost-efficient massage apparatuses are being released. Any type of instrument, device, or apparatus that performs the massage without a separate masseuse through a mechanical apparatus is referred to as a massage apparatus.

Recently, the massage apparatuses are equipped with various functions to improve the user's health. For example, the massage apparatuses sometimes include a function of pulling a spinal to relieve a pain of the spinal. However, most spinal pulling devices used to relieve the spinal pain to date use an axial traction by applying force in an axial direction of the spine. However, this method serves to straighten a spinal structure rather than decompress the intervertebral disc, which reduces the natural lordotic curve, causing muscle pain and spasm, and damage to the spinal facet joints and soft tissue structures, which can reduce the side effects of traction therapy.

### PRIOR ART DOCUMENT

### Patent Document

(Patent Document 1) Korean Patent Registration No. 10-2056545 (Dec. 17, 2019)

### Disclosure

### Technical Problem

The present disclosure is directed to disclosing a massage apparatus for pulling a spine while relieving a pain of a user or a method for operating the massage apparatus.

### Technical Solution

A method for operating a massage apparatus according to an embodiment of the present disclosure includes: controlling, by a control unit, a back frame to recline backward with respect to a hip frame so that a user becomes a lying posture; controlling, by the control unit, a leg massage part to be lifted up; controlling a location of a massage module so that a massage ball is positioned on a user's waist; and pulling the user's waist by moving the massage ball in at least one of a first direction and a second direction, and injecting air into a waist airbag, in which the first direction as a direction parallel to a longitudinal direction of an upper frame is a direction from a hip to a head of the user, and the second direction as a direction perpendicular to the longitudinal direction of the upper frame is a direction from a back to a front of the user.

In the method for operating a massage apparatus according to an embodiment of the present disclosure, the pulling of the user's waist includes moving the massage ball in the second direction, injecting air into the waist airbag simultaneously with, immediately before, or immediately after the moving of the massage ball in the second direction, moving the massage ball in the first direction or a direction opposite to the first direction, moving the massage ball in a direction opposite to the second direction, and discharging air from the waist airbag simultaneously with, immediately before, or immediately after the moving of the massage ball in the direction opposite to the second direction.

In the method for operating a massage apparatus according to an embodiment of the present disclosure, the pulling of the user's waist includes controlling, by the control unit, the location of the massage module so that the massage ball is positioned on a user's upper waist, injecting air into the waist airbag, moving the massage ball in the second direction so that the massage ball pressurizes the user, moving the massage module in the direction opposite to the first direction so that the massage ball is positioned on a user's lower waist, discharging air from the waist airbag, moving the massage ball in the direction opposite to the second direction so that the massage ball does not pressurize the user, and moving the massage module in the first direction so that the massage ball is positioned on the user's upper waist.

In the method for operating a massage apparatus according to an embodiment of the present disclosure, the controlling of the location of the massage module by the control unit so that the massage ball is positioned on the user's upper waist includes controlling the back frame to recline backward, and controlling, by the control unit, a leg massage part to be lifted up.

A massage apparatus for pulling a spine according to an embodiment of the present disclosure includes: a body massage part, a leg massage part, and a control unit controlling an operation of the massage apparatus, in which the body massage part includes a main frame including a base frame, the upper frame, and a lower frame, a massage module including a massage ball which is movable in the first direction or the direction opposite to the first direction along the upper frame, and movable in the second direction or the direction opposite to the second direction, and providing a massage to the user, and a waist airbag placed adjacent to a frame rotation axis between the back frame and the hip frame included in the upper frame, and pulling the user's waist.

In the method for operating a massage apparatus according to an embodiment of the present disclosure, the controlling of the location of the massage module by the control unit so that the massage ball is positioned on the user's upper waist includes injecting air into at least one airbag included in the leg massage part in order to fix user's legs, and injecting air into at least one airbag placed at both sides of the body massage part in order to fix an upper body of the user.

The massage apparatus according to an embodiment of the present disclosure includes an upper body fixing unit coupled to a cover of the body massage part, and positioned in the first direction from the waist airbag and having a belt shape extending left and right, and the upper body fixing unit has a first coupling part formed on one surface of one side and a second coupling part formed on the other surface of the other side, and the first coupling part and the second coupling part are coupled to fix the upper body of the user.

The method for operating a massage apparatus according to an embodiment of the present disclosure includes: checking, by the control unit, whether the first coupling part is coupled to the second coupling part based on a signal of a sensor unit; and controlling, by the control unit, the location of the massage module so that the massage ball is positioned on the user's upper waist when the first coupling part is coupled to the second coupling part, and the sensor unit is a contact sensor sensing whether the first coupling part and the second coupling part are in contact with each other.

In the method for operating a massage apparatus according to an embodiment of the present disclosure, the moving of the massage module in the direction opposite to the first direction so that the massage ball is positioned on the user's lower waist includes controlling the leg massage part to be lowered, and the discharging of air from the waist airbag includes controlling the leg massage part to be lifted up.

In the method for operating a massage apparatus according to an embodiment of the present disclosure, the massage module includes a module base frame forming a framework of the massage module, a massage ball rotation axis coupled to the module base frame and extending left and right, a massage ball frame rotating based on the massage ball rotation axis, and the massage ball connected to the massage ball frame, and when the massage ball frame is rotated based on the massage ball rotation axis, the massage ball protrudes in the second direction by a first distance, and moves in the direction opposite to the first direction by a second distance from an initial state of the massage ball, and the first distance is 5 cm or more and 15 cm or less, and the second distance is 5 cm or more and 10 cm or less.

A massage apparatus for pulling a spine according to an embodiment of the present disclosure includes: a body massage part, a leg massage part, and a control unit controlling an operation of the massage apparatus, and the body massage part includes a main frame including a base frame, the upper frame, and a lower frame, a massage module including a massage ball which is movable in the first direction or the direction opposite to the first direction along the upper frame, and movable in the second direction or the direction opposite to the second direction, and providing a massage to the user, and a waist airbag placed adjacent to a frame rotation axis between the back frame and the hip frame included in the upper frame, and pulling the user's waist, in which the first direction as a direction parallel to a longitudinal direction of an upper frame is a direction from a hip to a head of the user, and the second direction as a direction perpendicular to the longitudinal direction of the upper frame is a direction from a back to a front of the user.

The massage module of the massage apparatus according to an embodiment of the present disclosure includes a module base frame forming a framework of the massage module, a massage ball rotation axis coupled to the module base frame and extending left and right, a massage ball frame rotating based on the massage ball rotation axis, and the massage ball connected to the massage ball frame, and the massage ball frame is rotated based on the massage ball rotation axis, which moves the massage ball in the second direction.

In the massage apparatus according to an embodiment of the present disclosure, when the massage ball frame is rotated based on the massage ball rotation axis, the massage ball protrudes in the second direction by a first distance, and moves in the direction opposite to the first direction by a second distance from an initial state of the massage ball, and the first distance is 5 cm or more and 15 cm or less, and the second distance is 5 cm or more and 10 cm or less.

The massage apparatus according to an embodiment of the present disclosure includes at least one airbag included in a leg massage part fixing user's legs when injecting air, and at least one airbag placed at both sides of a body massage part fixing an upper body of the user when injecting air.

The massage apparatus according to an embodiment of the present disclosure includes an upper body fixing unit coupled to a cover of the body massage part, and positioned in the first direction from the waist airbag and having a belt shape extending left and right, and the upper body fixing unit has a first coupling part formed on one surface of one side and a second coupling part formed on the other surface of the other side, and the first coupling part and the second coupling part are coupled to fix the upper body of the user.

In the massage apparatus according to an embodiment of the present disclosure, the control unit checks whether the first coupling part is coupled to the second coupling part based on a signal of a sensor unit, and when the first coupling part is coupled to the second coupling part, the control unit pulls the user's waist based on the massage ball and the waist airbag, and herein, the sensor unit is a contact sensor sensing whether the first coupling part and the second coupling part are in contact with each other.

In the massage apparatus according to an embodiment of the present disclosure, the control unit controls a back frame to recline backward with respect to a hip frame, controls a leg massage part to be lifted up, controls the location of the massage module so that the massage ball is positioned on the user's waist, and pulls the user's waist based on the massage ball and the waist airbag.

In the massage apparatus according to an embodiment of the present disclosure, the control unit moves the massage ball in the second direction, injects air into the waist airbag simultaneously with, immediately before, or immediately after moving the massage ball in the second direction, moves the massage ball in the first direction or a direction opposite to the first direction, moves the massage ball in a direction opposite to the second direction, and discharges air from the waist airbag simultaneously with, immediately before, or immediately after the moving of the massage ball in the direction opposite to the second direction in order to pull the user's waist.

In the massage apparatus according to an embodiment of the present disclosure, the control unit controls the location of the massage module so that the massage ball is positioned on a user's upper waist, moves the massage ball in the second direction so that the massage ball pressurizes the user, moves the massage module in the direction opposite to the first direction so that the massage ball is positioned on a user's lower waist, injects air into the waist airbag, moves the massage ball in a direction opposite to the second direction so that the massage ball does not pressurize the user, discharges air from the waist airbag, and moves the massage module in the first direction so that the massage ball is positioned on the upper waist.

In the massage apparatus according to an embodiment of the present disclosure, the control unit controls the location of the massage module so that the massage ball is positioned on a user's lower waist, injects air into the waist airbag, moves the massage ball in the second direction so that the massage ball pressurizes the user, moves the massage module in the first direction so that the massage ball is positioned on the user's upper waist, discharges air from the waist airbag, moves the massage ball in a direction opposite to the second direction so that the massage ball does not pressurize the user, and moves the massage module in a direction opposite to the first direction so that the massage ball is positioned on the lower waist.

Additionally, a program for implementing the operating method of the massage apparatus as described above may be recorded on a computer-readable recording medium.

### Advantageous Effects

According to the present disclosure, a massage apparatus can pull a user's waist by using both a massage ball and a waist airbag of a massage module. The massage apparatus can have the same effect as a person pulling the waist with their hands by using two different types of massage devices. More specifically, an operation in which a person pulls the waist with fingertips or hand blades can be provided by a massage ball of the massage module, and an operation in which the person gently presses the user's waist with the palm of the hand may be provided by a waist airbag. In addition, the waist airbag has a large contact area with the user's waist, so the waist airbag can pull the user's waist without causing pain to the user.

### DESCRIPTION OF DRAWINGS

FIG. 1 is a diagram for describing a massage apparatus according to an embodiment of the present disclosure.

FIG. 2 is a diagram for describing a main frame according to an embodiment of the present disclosure.

FIG. 3 is a diagram for describing a main frame according to an embodiment of the present disclosure.

FIG. 4 is a diagram illustrating a massage apparatus according to an embodiment of the present disclosure.

FIG. 5 is a diagram illustrating an external apparatus which may communicate with a massage apparatus 100 according to an embodiment of the present disclosure.

FIG. 6 illustrates a control unit according to an embodiment of the present disclosure.

FIG. 7 is a diagram illustrating a massage apparatus according to an embodiment of the present disclosure.

FIG. 8 illustrates a cross section of the massage apparatus according to an embodiment of the present disclosure.

FIG. 9 is a flowchart for describing an operation of a massage apparatus according to an embodiment of the present disclosure.

FIG. 10 is a diagram for describing an operation of a massage apparatus according to an embodiment of the present disclosure.

FIG. 11 is a diagram illustrating a massage module according to an embodiment of the present disclosure.

FIG. 12 is a diagram for describing an upper body fixing unit according to an embodiment of the present disclosure.

FIG. 13 is a flowchart for describing an operation of a massage apparatus according to another embodiment of the present disclosure.

FIG. 14 is a flowchart for describing an operation of a massage apparatus according to another embodiment of the present disclosure.

FIG. 15 is a flowchart for describing an operation of a massage apparatus according to another embodiment of the present disclosure.

FIG. 16 is a diagram for describing an operation of a massage apparatus according to another embodiment of the present disclosure.

### BEST MODE

A method for operating a massage apparatus includes: controlling, by a control unit, a back frame to recline backward with respect to a hip frame so that a user becomes a lying posture; controlling, by the control unit, a leg massage part to be lifted up; controlling a location of a massage module so that a massage ball is positioned on a user's waist; and pulling the user's waist by moving the massage ball in at least one of a first direction and a second direction, and injecting air into a waist airbag, in which the first direction as a direction parallel to a longitudinal direction of an upper frame is a direction from a hip to a head of the user, and the second direction as a direction perpendicular to the longitudinal direction of the upper frame is a direction from a back to a front of the user.

### MODES OF THE INVENTION

Advantages and features of the disclosed exemplary embodiment of the present disclosure, and methods for accomplishing the same will be more clearly understood from embodiments described below with reference to the accompanying drawings. However, the present disclosure is not limited to the embodiments set forth below, and may be embodied in various different forms. The embodiments are just for rendering the disclosure of the present disclosure complete and are set forth to provide a complete understanding of the scope of the present disclosure to a person with ordinary skill in the technical field to which the present disclosure pertains.

Terms used in this specification will be described in brief and the disclosed exemplary embodiment will be described in detail.

Terms used in this specification adopt general terms which are currently widely used as possible by considering functions in the present disclosure, but the terms may be changed depending on an intention of those skilled in the art, a precedent, emergence of new technology, etc. Further, in a specific case, a term which an applicant arbitrarily selects is present and in this case, a meaning of the term will be disclosed in detail in a corresponding description part of the invention. Accordingly, a term used in the present disclosure should be defined based on not just a name of the term but a meaning of the term and contents throughout the present disclosure.

A singular expression in this specification includes a plural expression if there is no clearly singular meaning in the context. Further, the plural expression includes the singular expression if there is no clearly plural meaning in the context.

Further, throughout the specification, unless explicitly described to the contrary, the word “comprise” and variations such as “comprises” or “comprising”, will be understood to imply the inclusion of stated elements but not the exclusion of any other elements.

Further, the term “unit” or “part” used in this specification means software and hardware components and the “unit” performs predetermined roles. However, the “unit” is not a meaning limited to software or hardware. The “unit” may be configured to reside on an addressable storage medium and may be configured to play back one or more processors.

Accordingly, as one example, the “unit” includes components such as software components, object-oriented software components, class components, and task components, processes, functions, attributes, procedures, subroutines, segments of a program code, drivers, firmware, microcode, circuitry, data, databases, data structures, tables, arrays, and variables. Functions provided in the components and the “units” may be combined into a smaller number of components and “units” or further separated into additional components and “units”.

According to an embodiment of the present disclosure, the “unit” may be implemented by a processor and a memory. The term “processor” should be interpreted broadly to include general purpose processors, central processing units (CPUs), microprocessors, digital signal processors (DSPs), controllers, microcontrollers, state machines, etc. In some environments, the “processor” may refer to an application-specific integrated circuit (ASIC), programmable logic device (PLD), field programmable gate array (FPGA), etc. The term “processor” refers to a combination of processing devices, for example, a combination of a DSP and a microprocessor, a combination of a plurality of microprocessors, a combination of one or more microprocessors in combination with a DSP core, or any other such combination of configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, etc. The memory may be regarded to be in electronic communication with a processor if the processor can read information from and/or write information to the memory. The memory integrated into the processor is in electronic communication with the processor.

In this specification, an actuator refers to a component that can provide a driving force. For example, the actuator may include, but is not limited to, a motor, linear motor, electronic motor, DC motor, AC motor, linear actuator, electric actuator, etc.

In this specification, according to an embodiment, a massage apparatus may refer to a massage apparatus including a body massage part and a leg massage part. Further, according to another embodiment, the body massage part 2100 and the leg massage part 2300 may exist as separate apparatuses (for example, a body massage apparatus and a leg massage apparatus), and the massage apparatus may refer to the body massage apparatus or the leg massage apparatus.

An embodiment of the present disclosure will be described more fully hereinafter with reference to the accompanying drawings so as to be easily implemented by those skilled in the art. In addition, a part which is not related to the description is omitted in the drawings in order to clearly describe the present disclosure.

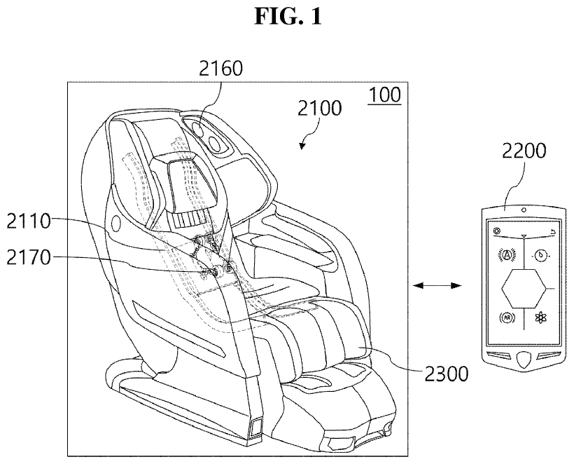

FIG. 1 is a diagram for describing a massage apparatus according to an embodiment of the present disclosure.

The massage apparatus 100 according to an embodiment of the present disclosure may include a body massage part 2100 which forms a region for accommodating at least a portion of a user's body and massages a user's body, and a leg massage part 2300 which massages user's legs. For example, the leg massage part 2300 may be placed below the body massage part 2100 and may provide a massage to the user's legs.

The body massage part 2100 may provide the massage to at least a part of the user's body. The body massage part 2100 may include a massage module 2170 providing a massage function to at least a part of the user's body, an audio output module 2160 providing an arbitrary form of audio output to the user, a main frame 2110 constituting a framework of the body massage part 2100, and a user input unit for receiving any type of input from the user.

The components included in the body massage part 2100 described above are merely exemplary embodiments, and the body massage part 2100 may include various components in addition to the components described above.

In addition, a shape and a structure of the massage apparatus 100 illustrated in FIG. 1 are merely exemplary, and as long as they do not depart from the scope defined by the claims of the present disclosure, various types of massage apparatuses 100 may also be included in the scope of the present disclosure.

The body massage part 2100 may form any form of space for accommodating the user. The body massage part 2100 may be provided with a space having a form corresponding to a shape of the user's body. For example, as illustrated in FIG. 1, the body massage part 2100 may be implemented as a seated type that may accommodate an entire body of the user and/or a part of the body.

A portion in contact with the ground in the body massage part 2100 may include any material for increasing friction force and/or any member (e.g., an anti-slip pad, etc.) for increasing the friction force, and may include wheels for enhancing the mobility of the massage apparatus 100.

At least a part of the body massage part 2100 may slide. For example, when the body massage part 2100 starts the massage, at least a part of the body massage part 2100 may slide forward. Additionally, the body massage part 2100 may recline backward. As a result, the body massage part 2100 may provide the massage while reclining backward.

According to an embodiment of the present disclosure, the massage apparatus 100 may include at least one air cell (not illustrated, an airbag). The air cell may be positioned in a shoulder part, a waist part, a pelvic part, an arm massage part, the leg massage part 2300, etc., but is not limited thereto and may be placed in various parts of the massage apparatus 100. The arm massage units may be placed at both sides of the body massage part 2100, and may provide the massage to arms of the user.

The massage apparatus 100 may include an air supply unit, and the air supply unit may inflate the air cell by supplying air to the air cell. The air supply unit may be positioned inside the body massage part 2100 and may be positioned in the leg massage part 2300. Further, the air supply unit may be positioned outside the massage apparatus 100.

The leg massage part 2300 may provide a leg massage to the user. For example, the leg massage part 2300 may include a calf massage part that massages a calf of the user and/or a foot massage part that massages feet of the user.

A length of the leg massage part 2300 may be adjustable according to body characteristics of the user. For example, when a tall user uses the massage apparatus 100, the length of the leg massage part 2300 needs to be increased because a length of the calf is long. Additionally, when a short user uses the massage apparatus 100, the leg massage part 2300 needs to be shortened because the length of the calf is short. Accordingly, the leg massage part 2300 may provide a leg massage customized to a height of the user.

The massage module 2170 may be provided inside the body massage part 2100 to provide any type of mechanical stimulation to the user accommodated in the body massage part 2100. As illustrated in FIG. 1, the massage module 2170 may move along the main frame 2110 provided inside the body massage part 2100.

For example, the main frame 2110 of the body massage part 2100 may be equipped with a rack gear, and the massage module 2170 may provide the mechanical stimulation to various parts of the user's body while moving along the rack gear. The massage module 2170 may include, but is not limited to, a ball massage unit and/or a roller massage unit.

The main frame 2110 which constitutes a framework of an internal structure of the body massage part 2100 may be implemented by a metallic material and/or a plastic material, etc. For example, the main frame 2110 may be implemented by iron, alloy, steel, etc., but is not limited thereto and may be made of various hard materials.

According to an embodiment of the present disclosure, the massage apparatus 100 may include an audio output module 2160. The audio output module 2160 may be provided at various locations. For example, the audio output module 2160 may include a plurality of output units such as a top audio output unit placed on the top of a seat in contact with the user, front audio output units attached to front ends of the arm massage parts on left and right sides of the seat, and/or rear audio output units attached to rear ends of the arm massage parts, but is not limited thereto. In this case, the audio output module 2160 may provide a three-dimensional sound such as 5.1 channel, but is not limited thereto. The arm passage parts may be placed at least one of both sides of the body massage part 2100, and may provide the massage to the arms of the user.

According to an embodiment of the present disclosure, the user may control the massage apparatus 100 using a massage apparatus control device 2200. The massage apparatus control device 2200 may be connected to the massage apparatus 100 through wired communication and/or wireless communication.

The massage apparatus control device 2200 may include a remote controller, a cellular phone, a personal digital assistant (PDA), etc., and is not limited thereto, and may include various electronic devices which are connectable to the massage apparatus 100 through wired and/or wireless communication.

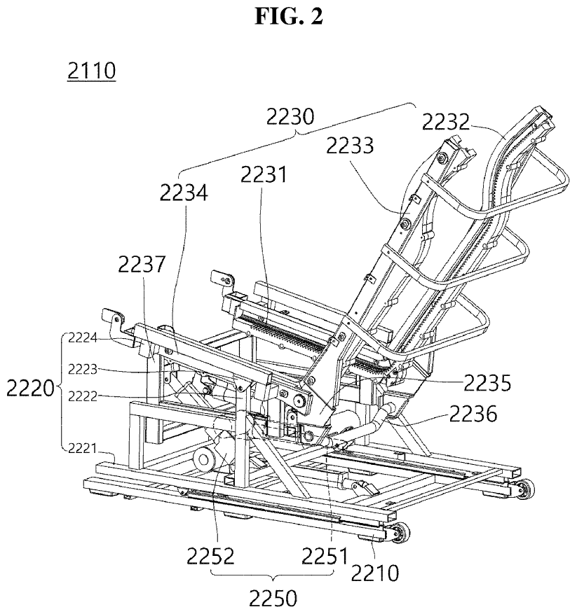

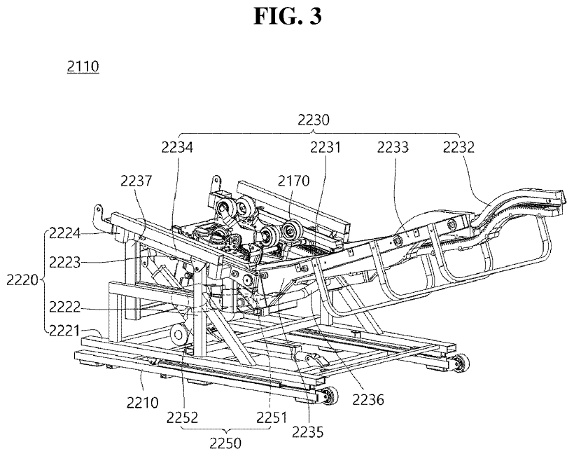

FIGS. 2 and 3 are diagrams for describing a main frame according to an embodiment of the present disclosure. Specifically, FIG. 3 is a diagram illustrating a state in which an angle of a back frame 2232 is changed.

According to an embodiment of the present disclosure, the main frame 2110 may include at least one of a base frame 2210, a lower frame 2220, and an upper frame 2230. Additionally, a frame actuator 2250 and a massage module 2170 may be placed in the main frame 2110 according to an embodiment of the present disclosure.

The base frame 2210 is placed on the ground to stably support the massage apparatus 100. The base frame 2210 may be supported by the ground and may support the lower frame 2220 and the upper frame 2230. According to an example, the base frame 2210 may be comparatively broadly placed to control a center of gravity of the massage apparatus 100, but is not limited thereto.

The lower frame 2220 may support the upper frame 2230. The lower frame 2220 according to an example may directly support a hip frame 2231 of the upper frame 2230. The lower frame 2220 according to an example may be vertically placed on one side and the other side of the base frame 2210 and may support the upper frame 2230, but is not limited thereto.

According to an embodiment of the present disclosure, the lower frame 2220 may move along the base frame 2210. For example, the lower frame 2220 may slide forward or backward along the base frame 2210. As a result, sliding movement of the body massage part 2100 may be permitted.

Specifically, in order to permit the lower frame 2220 to move, a moving wheel may be provided at a lower portion of the lower frame 2220. Additionally, a guide member capable of guiding the moving wheel may be provided at an upper portion of the base frame 2210. The moving wheel provided in the lower frame 2220 may be permitted to move forward or backward by moving along the guide member provided on the base frame 2210.

According to another example of the present disclosure, the lower frame 2220 and the base frame 2210 are not separated but are formed as one, so that the lower frame 2220 may be fixed without moving along the base frame 2210. For example, the lower frame 2220 may be fixed without sliding forward or backward.

Specifically, no moving wheel is provided at the lower portion of the lower frame 2220, and a fixing member for fixing the lower frame 2220 and the base frame 2210 may be provided between the lower frame 2220 and the base frame 2210. Additionally, the lower frame 2220 and the base frame 2210 may be configured integrally.

The lower frame 2220 according to an embodiment of the present disclosure may include at least one of a slide frame 2221, a support shaft frame 2222, a swing bracket 2223, and an upper and lower coupling frame 2224.

The slide frame 2221 may slide forward or backward along the base frame 2210. The slide frame 2221 may be placed on the base frame 2210, and may support the support shaft frame 2222.

The support shaft frame 2222 may serve as a support shaft supporting the upper frame 2230. Further, in the main frame 2110 according to an embodiment of the present disclosure, the entirety of the upper frame 2230 may move forward or backward, and in this case, the support shaft frame 2222 may serve as a central axis. One end of the support shaft frame 2222 may be coupled to the slide frame 2221, and the other end may be coupled to the swing bracket 2223.

The swing bracket 2223 supports the upper frame 2230 and allows the upper frame 2230 to rotate around the support shaft frame 2222. The upper and lower coupling frame 2224 is coupled to an upper surface of the swing bracket 2223, and when one end and the other end of the upper and lower coupling frame 2224 move, the swing bracket 2223 may serve to hold the center of the upper and lower coupling frame 2224.

A cross section of the swing bracket 2223 according to an example may have a triangular shape, but is not limited thereto. When the cross section of the swing bracket 2223 according to an example has the triangular shape, the support shaft frame 2222 may be inserted into a first vertex of the swing bracket 2223. In addition, a coupling member may penetrate the first vertex of the swing bracket 2223 and the support shaft frame 2222 at the same time, so that the swing bracket 2223 and the support shaft frame 2222 may be coupled, but a coupling method is limited thereto. At this time, a first bottom portion (an upper surface of the swing bracket 2223) facing the first vertex of the swing bracket 2223 may be coupled to the upper and lower coupling frame 2224.

The upper and lower coupling frame 2224 may couple the lower frame 2220 and the upper frame 2230. A portion of a bottom of the upper and lower coupling frame 2224 according to an example may be coupled to the swing bracket 2223. Additionally, one end and the other end of the upper and lower coupling frame 2224 according to an example may be coupled to the upper frame 2230. More specifically, one end and the other end of the upper and lower coupling frame 2224 according to an example may be coupled to a side connection frame 2234 of the upper frame 2230. The upper and lower coupling frame 2224 may also move according to the movement of the side connection frame 2234.

The frame actuator 2250 may be placed in the lower frame 2220 according to an embodiment of the present disclosure.

The frame actuator 2250 may provide driving force to move at least one of a rear connection frame 2236, the lower frame 2220, the upper frame 2230, and a leg frame (not illustrated) provided in the leg massage part. The frame actuator 2250 according to an embodiment of the present disclosure may include at least one of a conformal angle actuator 2251, a swing motion actuator 2252, a sliding actuator (not illustrated), and a leg angle actuator (not illustrated).

The conformal angle actuator 2251 may adjust an angle of the back frame 2232. One side of the conformal angle actuator 2251 according to an example may be fixed to the lower frame 2220, and the other side may be fixed to the rear connection frame 2236. The conformal angle actuator 2251 moves the rear connection frame 2236 forward or backward to adjust the angle of the back frame 2232.

The swing motion actuator 2252 may adjust an angle of the upper frame 2230. One side of the swing motion actuator 2252 according to an example may be fixed to the upper frame 2230, and the other side may be fixed to the lower frame 2220. The swing motion actuator 2252 moves the upper frame 2230 forward or backward to adjust an entire angle of the upper frame 2230.

The sliding actuator (not illustrated) may slide the body massage part 2100. One side of the sliding actuator (not illustrated) according to an example may be fixed to the base frame 2210, and the other side may be fixed to the lower frame 2220. The sliding actuator (not illustrated) moves the lower frame 2220 in forward or backward direction so that the lower frame 2220 may slide forward or backward along the base frame 2210, and as a result, the body massage part 2100 may slide.

The leg angle actuator (not illustrated) may adjust an angle of the leg massage part. One side of the leg angle actuator (not illustrated) according to an example may be fixed to the upper frame 2230, and the other side may be fixed to a leg frame (not illustrated). The leg angle actuator (not illustrated) moves the leg frame (not illustrated) forward or backward to adjust the angle of the leg massage part.

The upper frame 2230 may serve as a framework supporting a user's body. The upper frame 2230 may support a hip part and a back part of the user. The upper frame 2230 may be supported by the lower frame 2220. The massage module 2170 is placed in the upper frame 2230 to massage the user's body.

The upper frame 2230 according to an embodiment of the present disclosure may include at least one of a hip frame 2231, a back frame 2232, an anti-deformation frame 2233, a side connection frame 2234, a connection bracket 2235, a rear connection frame 2236, and a front connection frame 2237.

The hip frame 2231 may support the hip part of the user. The hip frame 2231 may be constituted by a plurality of frames, and may be provided in a form to face each other at both sides of the lower frame 2220. The hip frame 2231 according to an example may be configured by a separate frame from the back frame 2232. A hip rack gear may be provided in the hip frame 2231.

The hip rack gear which is for guiding the movement of the massage module 2170 may include a plurality of rack gear protrusions and a plurality of rack gear grooves. The hip rack gears may be provided in a form to face each other at both sides of the hip frame 2231, and the massage module 2170 may move along the hip rack gear. The hip rack gear as a separate member may also be provided in the hip frame 2231, but may also be formed in a part of the hip frame 2231 in a pattern form.

The back frame 2232 may support the back part of the user. The back frame 2232 may be placed adjacent to the hip frame 2231, and provided in a form to face each other at both sides of the lower frame 2220. The back frame 2232 may be separated from the hip frame 2231 and move as a separate frame in order to permit the angle with the hip frame 2231 to be changed.

The back frame 2232 according to an example may be implemented in various shapes. For example, the back frame 2232 may be classified into an I frame, an S frame, etc., according to the shape thereof, but is not limited thereto.

The I frame means a frame in which at least a part of the back frame 2232 is implemented in an “I” shape. The S frame means a frame in which at least a part of the back frame 2232 includes a curved shape like “S”. When the massage module 2170 is provided in the I frame, the massage module 2170 is movable in a straight line along the I frame.

A back rack gear may be provided in the back frame 2232. The back rack gear which is for guiding the movement of the massage module 2170 may include a plurality of rack gear protrusions and a plurality of rack gear grooves. The back rack gears may be provided in a form to face each other at both sides of the back frame 2232, and the massage module 2170 may move along the back rack gear. The back rack gear as a separate member may also be provided in the back frame 2232, but may also be formed in a part of the back frame 2232 in the pattern form.

The hip frame 2231 and the back frame 2232 according to an embodiment of the present disclosure may be configured as separate frames, and ends of the respective frames may be placed adjacent to each other. An angle adjustment protrusion may be provided at a lower portion of one end of the hip frame 2231 or the back frame 2232 according to an embodiment of the present disclosure, and an angle adjustment guide with a protrusion insertion groove may be provided at the lower portion of one end of the hip frame 2231 or the back frame 2232 without the angle adjustment protrusion. The angle adjustment protrusion is inserted into the protrusion insertion groove of the angle adjustment guide, so the hip frame 2231 and the back frame 2232 may maintain a distance without being spaced apart from each other by a predetermined interval while angles of the hip frame 2231 and the back frame 2232 are adjusted.

The hip frame 2231 and the back frame 2232 according to an embodiment of the present disclosure may be implemented as the plastic material or the metallic material, but are not limited thereto. The hip rack gear may be formed in the pattern form in the hip frame 2231 according to an embodiment of the present disclosure, and the back rack gear may be formed in the pattern form in the back frame 2232, and in this case, the hip frame 2231 and the back frame 2232 may be made of the plastic material. Here, being formed in the pattern form may mean that a rack gear pattern is engraved on the frame. However, being formed in the pattern form is not limited thereto.

The anti-deformation frame 2233 may be placed at a side portion of the back frame 2232 and may support the back frame 2232 in order to prevent the form of the back frame 2232 from being deformed or shaken when the back frame 2232 is made of the plastic material. For example, the anti-deformation frame 2233 may be implemented by iron, alloy, steel, etc., but is not limited to this and may be implemented by various hard materials.

The side connection frame 2234 may fix the hip frame 2231 to the lower frame 2220. One surface of the side connection frame 2234 according to an example may be coupled to the hip frame 2231, and the other surface may be coupled to the lower frame 2220. More specifically, the side connection frame 2234 according to an example may be coupled to the upper and lower coupling frame 2224 of the lower frame 2220.

The connection bracket 2235 may connect the anti-deformation frame 2233 and the side connection frame 2234. The connection bracket 2235 according to an example is made in the form of a triangular thin plate, and a first vertex may be coupled to the anti-deformation frame 2233, a second vertex may be coupled to the side connection frame 2234, and a third vertex may be coupled to the rear connection frame 2236, but is not limited thereto. The connection bracket 2235 may include a first connection bracket and a second connection bracket placed to face each other on both sides of the lower frame 2220.

Meanwhile, the connection bracket 2235 may be provided separately and combined with the anti-deformation frame 2233, but may also extend from the anti-deformation frame 2233 and be formed integrally.

The rear connection frame 2236 may connect the back frame 2232 and the conformal angle actuator 2251. The rear connection frame 2236 may be connected to the back frame 2232 through the connection bracket 2235 and the anti-deformation frame 2233. Accordingly, when the rear connection frame 2236 is moved, the angle of the back frame 2232 may be adjusted. More specifically, when the rear connection frame 2236 is moved, the connection bracket 2235 connected to the rear connection frame 2236 may rotate around a frame rotation axis 2238, and the angle of the back frame 2232 connected to the connection bracket 2235 may be adjusted. The rear connection frame 2236 is connected to the conformal angle actuator 2251, and the conformal angle actuator 2251 moves the rear connection frame 2236 forward or backward, thereby adjusting the angle of the back frame 2232. The rear connection frame 2236 may be coupled to the third vertex of the connection bracket 2235, and coupled between the first connection bracket and the second connection bracket.

The front connection frame 2237 may connect the upper frame 2230 and the swing motion actuator 2252. The front connection frame 2237 according to an example may be coupled to the side connection frame 2234 of the upper frame 2230. Accordingly, when the front connection frame 2237 is moved, the entire angle of the upper frame 2230 may be adjusted.

According to an embodiment of the present disclosure, the massage module 2170 may be placed in the upper frame 2230.

The massage module 2170 may provide the mechanical stimulation to at least one of the head part, the back part, and the hip part of the user. The massage module 2170 may move upward or downward along the hip frame 2231 and the back frame 2232.

Meanwhile, since the hip frame and the back frame of a conventional massage apparatus are configured as one frame, and an angle between the hip frame and the back frame may not be adjusted, there is inconvenience that the user should receive the massage with the same posture. Further, the conventional massage apparatus has a problem in that even though the angle between the hip frame and the back frame is adjusted, it is difficult for the massage module 2170 to move between the hip frame and the back frame.

The massage apparatus 100 according to an embodiment of the present disclosure may adjust the angle between the hip frame 2231 and the back frame 2232 by separating the hip frame 2231 and the back frame 2232 from each other. In addition, the massage apparatus 100 according to an embodiment of the present disclosure includes a guide module in the massage module 2170 to prevent the massage module 2170 from being separated between the hip frame 2231 and the back frame 2232.

The hip rack gear or the back rack gear may include a front-back direction rack gear and an up-down direction rack gear. In the present disclosure, the front-back direction may refer to a direction from the massage module 2170 to the user or from the user to the massage module 2170, and may also be referred to as a Z-axis direction.

The massage module 2170 may include a gear engaged with the hip rack gear or the back rack gear. More specifically, the massage module 2170 may include gears engaged with the front-back direction rack gear and the up-down direction rack gear, respectively. The gear is rotated by the actuator provided in the massage module 2170, so the massage module 2170 may move forward, backward, upward, or downward.

As the massage module 2170 moves forward, the intensity of the massage may increase. Further, as the massage module 2170 moves backward, the intensity of the massage may decrease.

The rack gear may be implemented by the metallic material or plastic material. For example, the rack gear may be implemented by iron, steel, alloy, reinforced plastic, melamine resin, phenol resin, etc., but is not limited thereto.

FIGS. 2 and 3 illustrate a case where the upper frame 2230 is a full flat frame, but the present disclosure is not limited thereto. The upper frame 2230 may be implemented in various shapes. For example, the upper frame 2230 may be classified into an S frame, an L frame, an S & L frame, and a double S & L frame, according to the shape thereof, but is not limited thereto.

The S frame means a frame in which at least a part of the upper frame 2230 includes a curved shape like “S”. The L frame refers to a frame in which at least part of the upper frame 2230 includes a bent shape like “L,” the S & L frame refers to a frame that includes both the curved shape like “S” and the bent shape like “L”, and the double S & L frame refers to a frame that includes the bent shape like “L” and the curved shape like “S” of two parts.

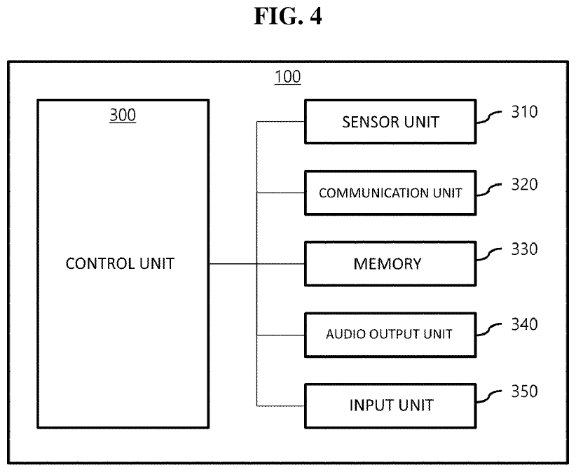

FIG. 4 is a diagram illustrating a massage apparatus according to an embodiment of the present disclosure.

The massage apparatus 100 may include at least one of a control unit 300, a sensor unit 310, a communication unit 320, a memory 330, an audio output unit 340, and an input unit 350. The control unit 300 may include at least one processor and a memory. At least one processor may perform instructions stored in the memory.

The control unit 300 may control the operation of the massage apparatus 100. The control unit 300 may include one processor or may include a plurality of processors. When the control unit 300 includes the plurality of processors, at least some of the plurality of processors may be positioned physically spaced apart from each other. Additionally, the massage apparatus 100 is not limited thereto and may be implemented in various modes.

According to an embodiment of the present disclosure, the control unit 300 may control the operation of the massage apparatus 100. For example, the massage apparatus 100 may include a plurality of actuators, and the massage apparatus 100 may control the operation of the massage apparatus 100 by controlling operations of the plurality of actuators. For example, the massage apparatus 100 may include at least one of a driving unit that moves an armrest frame support, a massage module (2170) movement actuator, at least one actuator included in the massage module, a back angle actuator, a leg angle actuator, a foot massage actuator, and a leg length adjustment actuator, and a sliding actuator, and the control unit 300 may control the operation of the massage apparatus 100 by controlling the actuators.

The massage module movement actuator is an actuator that allows the massage module 2170 to move up and down, and by the operation of the massage module (2170) movement actuator, the massage module 2170 may move along the rack gear.

The back angle actuator is an actuator that adjusts an angle of a part contacting the back of the user in the massage apparatus 100, and a back angle of the massage apparatus 100 may be adjusted by the operation of the back angle actuator.

The leg angle actuator is an actuator that adjusts the angle of the leg massage part 2300 of the massage apparatus 100, and an angle between the leg massage part 2300 and the body massage part 2100 may be adjusted by the operation of the leg angle actuator.

The foot massage actuator refers to an actuator that operates a foot massage module included in the leg massage part 2300. The massage apparatus 100 may provide the foot massage to the user by using the foot massage actuator.

The massage module 2170 may include at least one actuator, and the control unit 300 may provide various massage operations by operating at least one actuator. For example, the control unit 300 may provide a tapping massage, a kneading massage, etc., by operating at least one actuator included in the massage module 2170, but is not limited thereto and may provide various massage operations.

The leg length adjustment actuator refers to an actuator that adjusts the length of the leg massage part 2300. For example, the control unit 300 may use a leg length adjustment actuator to adjust the length of the leg massage part 2300 to suit the user, and as a result, the user may receive a massage tailored to his or her body type.

The sliding actuator enables a sliding operation of the massage apparatus 100. For example, a horizontal base upper frame may move forward or backward by the operation of the sliding actuator, and as a result, an upper frame connected to the horizontal base upper frame may also move forward or backward.

The memory 330 may be included in the control unit 300 or may be present outside the control unit 300. The memory 330 may store various information related to the massage apparatus 100. For example, the memory 330 may include massage control information and personal authentication information, but is not limited thereto.

The memory 330 may be implemented through a non-volatile storage medium which may persistently store arbitrary data. For example, the memory 330 may include disks, optical disks, and magneto-optical storage devices, as well as storage devices based on flash memory and/or battery-backup memory, but is not limited thereto.

The memory 330 as a primary storage device directly accessed by the processor, such as a random access memory (RAM) including a dynamic random access memory (DRAM), a static random access memory (SRAM), etc., may mean a volatile storage device in which stored information is momentarily erased when power is turned off, but is not limited thereto. The memory 330 may be operated by the control unit 300.

The massage apparatus 100 may include a sensor unit 310. The sensor unit 310 may acquire various information using at least one sensor. The sensor unit 310 may be provided as a sensor that uses measurement means such as pressure, potential, and optics. For example, the sensors may include, but are not limited to, a pressure sensor, an infrared sensor, an LED sensor, a touch sensor, and the like.

Additionally, the sensor unit 310 may include a biometric information acquisition sensor. The biometric information acquisition sensor may acquire fingerprint information, face information, voice information, iris information, weight information, electrocardiogram information, body composition information, etc., but is not limited thereto and may include various biometric information.

According to another embodiment of the present disclosure, the massage apparatus 100 may detect a contact area and/or a contact location with the user through the sensors. Additionally, the massage apparatus 100 may provide a customized massage based on the information acquired through the sensors. Further, the massage apparatus 100 may include a communication unit 320. The communication unit 320 of the massage apparatus 100 may receive a signal from an external apparatus. The control unit 300 may acquire a result signal by processing the received signal. The communication unit 320 may output the result signal to the external apparatus.

The communication unit 320 may communicate with a module inside the massage apparatus 100, an external massage apparatus, and/or a user terminal through any type of network. The communication unit may include a wired/wireless connection module for network connection. As the wireless connection technology, wireless LAN (WLAN) (Wi-Fi), wireless broadband (Wibro), world interoperability for microwave access (Wimax), high speed downlink packet access (HSDPA), or the like, may be used. As a wired connection technology, for example, digital subscriber line (XDSL), fibers to the home (FTTH), power line communication (PLC), and the like may be used. Additionally, the network connection unit may include a short-range communication module and may transmit and receive data with any apparatus/terminal positioned in a short range. For example, as short-range communication technology, Bluetooth, radio frequency identification (RFID), infrared data association (IrDA), ultra-wideband (UWB), ZigBee, or the like may be used, but is not limited thereto.

Additionally, the massage apparatus 100 may further include an input unit 350 or an output unit. The massage apparatus 100 may receive an input from the user using the input unit 350. Additionally, the massage apparatus 100 may output a processing result of the control unit 300 to the output unit.

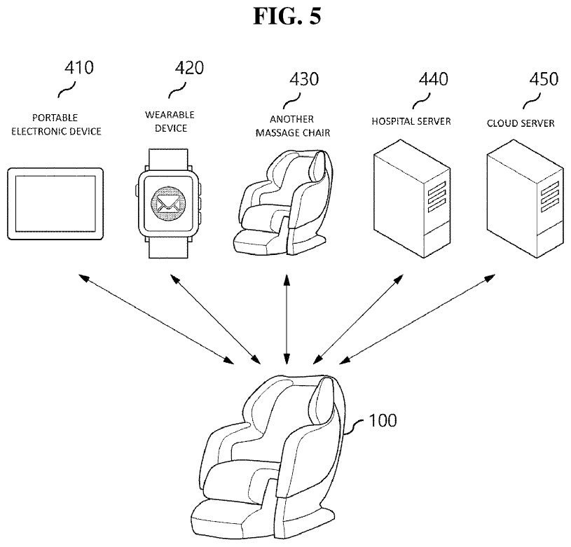

Specifically, the input unit 350 may receive an instruction related to operation control of the massage apparatus 100 from the user, and the input unit 350 may be implemented in various forms. For example, the input unit 350 may be provided in the body massage part 2100 or the leg massage part 2300, but is not limited thereto. Additionally, the input unit 350 may include the user input unit 2180, the massage apparatus control device 2200 of FIG. 1, or various external apparatuses that will be described in FIG. 5.

The massage apparatus 100 may acquire various instructions from the user through the input unit 350. For example, the massage apparatus 100 may receive an arbitrary instruction for selection of the massage module, selection of a massage type, selection of massage intensity, selection of massage time, selection of a massage portion, selection of a location and an operation of the body massage part 2100, selection of power on/off of the massage apparatus 100, selection of whether to operate a heating function, selection related to sound source reproduction, etc., but is not limited thereto.

The massage apparatus 100 may provide an interface to select a massage mode. For example, the input unit 350 or the output unit may include the massage apparatus control device 2200. Various modes of medical massage lists related to body improvement may be listed through the massage apparatus control device 2200.

The medical massage mode may include at least one of concentration mode, meditation mode, recovery mode, stretching mode, sleep mode, vitality mode, golf mode, hip-up mode, test taker mode, zero gravity mode, and growth mode.

According to another embodiment of the present disclosure, the input unit 350 may include hot key-type buttons and/or a selection button for executing direction selection, cancellation, and input according to a predetermined user setting function, an autonomously predetermined function, or the like.

The input unit 350 may be implemented by a keypad, a dome switch, a touch pad (resistive/capacitive), a jog wheel, and a jog switch, but is not limited thereto. Additionally, the input unit 350 may obtain commands through the user's speech based on voice recognition technology.

According to an embodiment of the present disclosure, the output unit may include a display for displaying an operation status of the massage apparatus 100, a current status of the user, or the like. In this case, the display may include at least one of a liquid crystal display (LCD), a thin film transistor-liquid crystal display (TFT LCD), an organic light-emitting diode (OLED), a flexible display, and a 3D display, and is not limited thereto.

The output unit may include an audio output unit 340. The audio output unit 340 may provide any type of audio output to the user. For example, the audio output unit 340 may provide brain stimulation to the user by outputting sound sources and/or binaural beats optimized for a massage pattern provided by the massage apparatus 100 to the user. The audio output unit 340 may output sound signals received through a network (not illustrated) or stored in an internal/external storage medium (not illustrated). For example, the audio output unit 340 may output a sound source under control of the user terminal through a network connection (e.g., Bluetooth connection, etc.) with the user terminal. Additionally, the audio output unit 340 may output any type of sound signal generated in relation to the operation of the massage apparatus 100.

It will be appreciated by those skilled in the art that the present disclosure may be implemented in combination with other program modules and/or as a combination of hardware and software. For example, the present disclosure may be implemented by a computer readable medium.

Media accessible by the computer may be computer readable media regardless of types thereof and the computer readable media include volatile and non-volatile media, transitory and non-transitory media, and movable and non-movable media. As a non-limitation example, the computer readable media may include both computer readable storage media and computer readable transmission media.

The computer readable storage media include volatile and non-volatile, temporary or non-temporary, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or any other media which may be accessed by the computer and may be used to store desired information, but are not limited thereto.

FIG. 5 is a diagram illustrating an external apparatus which may communicate with a massage apparatus 100 according to an embodiment of the present disclosure.

The massage apparatus 100 may communicate with an external apparatus wiredly or wirelessly to transmit and receive various data.

The external apparatuses may include portable electronic devices 410, such as AI speakers, tablets, or smartphones. The portable electronic device 410 may be dedicated to the massage apparatus 100 or may be a general-purpose portable electronic device. Additionally, the external apparatus may include a wearable device 420 such as a smart watch or smart band. The external apparatus may include another massage apparatus 430 other than the massage apparatus 100 which the user is currently using. The external apparatus may include a hospital server 440. The external apparatus may include a personal health record (PHR) server. The external apparatus may include a cloud server 450. The external apparatus may include a medical measurement device such as an electronic scale, a blood glucose monitor, or a blood pressure monitor.

Although the present disclosure describes some examples of the external apparatuses, it should be understood that all devices that may communicate with the massage apparatus 100 wiredly or wirelessly and exchange information with each other may be included in the external apparatus.

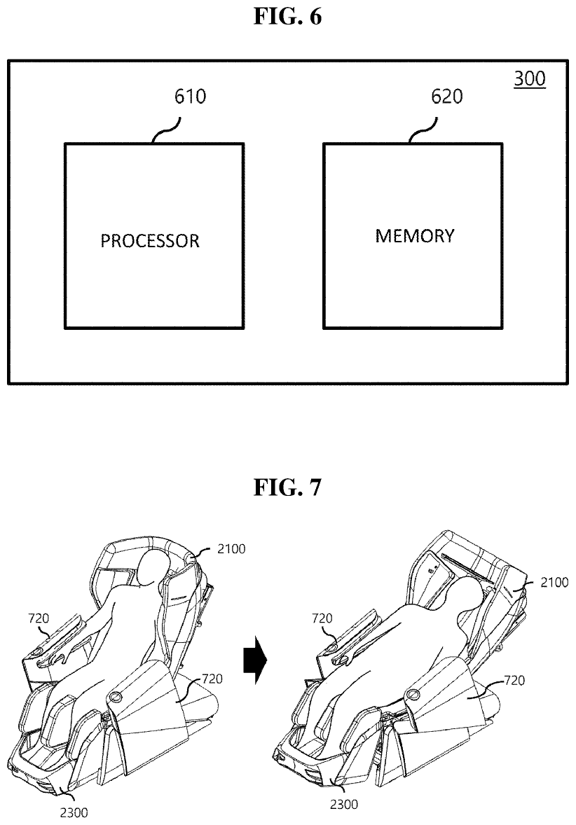

FIG. 6 illustrates a control unit according to an embodiment of the present disclosure.

The massage apparatus may include a control unit 300. The control unit 300 may include at least one of a processor 610 and a memory 620. The memory 620 may be the same as the memory 330. The processor 610 may perform operations based on instructions stored in the memory 620. The instructions stored in the memory 620 may be an application installed in the control unit 300. However, the present disclosure is not limited thereto, and the control unit 300 may include only the processor 610 and not a memory. The processor 610 may be set to output a predetermined signal to an output line for a predetermined time based on the input signal. Each component of the control unit 300 may perform a predetermined operation according to a signal. Hereinafter, the operation of the control unit 300 will be described in more detail.

FIG. 7 is a diagram illustrating a massage apparatus according to an embodiment of the present disclosure.

The massage apparatus 100 according to the present disclosure may include a body massage part 2100 and side covers 720. The side covers 720 may include an arm massage parts. Referring to a left figure of FIG. 7, the massage apparatus 100 may provide a massage to legs, arms, torso, etc. of the user when the user is in a sitting posture. Also, referring to a right figure of FIG. 7, the massage apparatus 100 may make the back frame 2232 recline backward. When the back frame 2232 reclines backward, the user may be in a lying down state. When the user lies down, the arms of the user may move backward along the back frame 2232. At this time, the side covers 720 including the arm massage parts may move backward and downward with respect to the massage apparatus 100. Since the side covers 720 move backward and downward, the massage apparatus 100 may accommodate the user's arms in the arm massage parts and provide the massage to the user's arms even if the user lies down. Additionally, the user may receive the massage without any discomfort.

FIG. 7 illustrates a state in which the leg massage part 2300 is folded, but the leg massage part 2300 may be lifted up. Therefore, the user may be in a state with his/her legs straight.

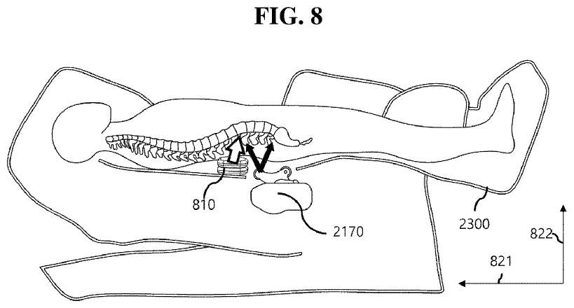

FIG. 8 illustrates a cross section of the massage apparatus according to an embodiment of the present disclosure.

Unlike FIG. 7, FIG. 8 illustrates the leg massage part in a lifted state. The massage apparatus 100 may include a waist airbag 810. The waist airbag 810 may be fixed to the massage apparatus 100. When air is injected into the waist airbag 810, the waist airbag 810 inflates to apply pressure to the user's waist and pull the user's waist. For example, the waist airbag 810 may inflate in a first direction and in a direction opposite to the first direction. The waist airbag 810 may be positioned at a concave portion of a user's waist. When the air is injected, the waist airbag 810 may inflate and push the user's lower back in the first direction and push an upper hip in the direction opposite to the first direction. Accordingly, the user's waist may be pulled. Additionally, when the air is injected, the waist airbag 810 may inflate and pressurize the user's waist in a second direction or support the user's waist.

The waist airbag 810 has a large contact area with the user's waist, so the waist airbag may pull the user's waist without causing pain to the user. The waist airbag 810 may provide comfort to the user while pulling the user's waist. The operation of the waist airbag 810 will be described in more detail below.

The massage apparatus 100 may include the massage module 2170. As already described, the massage module 2170 may move along the main frame 2110. The massage apparatus 100 may recognize a location of the user's shoulders and approximately determine a location of the user's waist based on the location of the user's shoulders. The massage apparatus 100 may position the massage module 2170 on the user's waist. Further, the massage apparatus 100 moves the massage ball of the massage module 2170 to the user to pull the user's waist. Additionally, the massage module 2170 may pull the user's waist while moving in the direction of the user's head or legs. The massage module 2170 may pressurize a specific portion of the user's waist. An area where the massage module 2170 applies acupressure may be smaller than an area where the waist airbag 810 presses the user. The massage apparatus 100 moves the massage ball while performing the acupressure on a narrow portion using the massage ball of the massage module 2170 to pull the waist. The massage apparatus 100 may effectively pull the user's waist while giving the feeling of a person pulling the waist through the waist airbag 810 and the massage ball. A process by which the massage module 2170 pulls the user's waist will be described in more detail below.

The massage apparatus 100 may provide a function for pulling the spine. The massage apparatus 100 may include a body massage part 2100, a leg massage part 2300, and a control unit 300 that controls the operation of the massage apparatus. The body massage part 2100 may include a main frame 2110. The main frame 2110 may include a base frame 2210, an upper frame 2230, and a lower frame 2220.

The body massage part 2100 may include a massage module 2170 that provides tapping, swing, acupressure massage, and the like to the user. The massage module 2170 may move along the upper frame 2230 in a first direction 821 or in a direction opposite to the first direction. The massage module 2170 may include a massage ball that is movable in a second direction 822 or in a direction opposite to the second direction.

Here, the first direction 821 is a direction parallel to a longitudinal direction of the upper frame and may be a direction from the user's hip (or legs) to the head. Additionally, the first direction 821 may extend from the knees to the hip. The direction opposite to the first direction 821 may be a direction from the user's head to the hip (or legs). The second direction 822 is a direction perpendicular to the longitudinal direction of the upper frame and may be a direction from the back to the front of the user. The direction opposite to the second direction 822 may be a direction from the front to the back of the user.

The first direction 821 may be a direction parallel to the direction of the rack gear included in the main frame 2110. Further, the second direction 822 may be a direction perpendicular to the direction of the rack gear included in the main frame 2110. In FIG. 8, the body massage part 2100 is laid back and the user is lying down, so the first direction 821 may be a direction parallel to the ground and the second direction 822 may be a direction perpendicular to the ground. However, as in a left figure of FIG. 7, when the body massage part 2100 is standing and the user is sitting, the first direction 821 is a direction perpendicular to the ground, and the second direction 822 may be a direction parallel to the ground. The first direction 821 and the second direction 822 may be directions that change depending on the posture of the body massage part 2100. The first direction 821 and the second direction 822 may be substantially perpendicular.

The body massage part 2100 may include a waist airbag 810 that pulls the user's waist. The waist airbag 810 may be positioned around the user's waist. The waist airbag 810 may apply pressure to the entirety of the waist. The waist airbag 810 may be placed adjacent to a frame rotation axis 2238 between the back frame 2232 and the hip frame 2231 included in the upper frame 2230. The waist airbag 810 may be placed between the upper frame 2230 and a cover covering the upper frame 2230. Here, the cover may include a cushion to provide aesthetics and make the user feel comfortable. The waist airbag 810 may be placed at a location fixed to the main frame. The waist airbag 810 may press a specific part of the user's waist. Unlike the massage module 2170, the waist airbag 810 may pressurize a specific part of the user's waist.

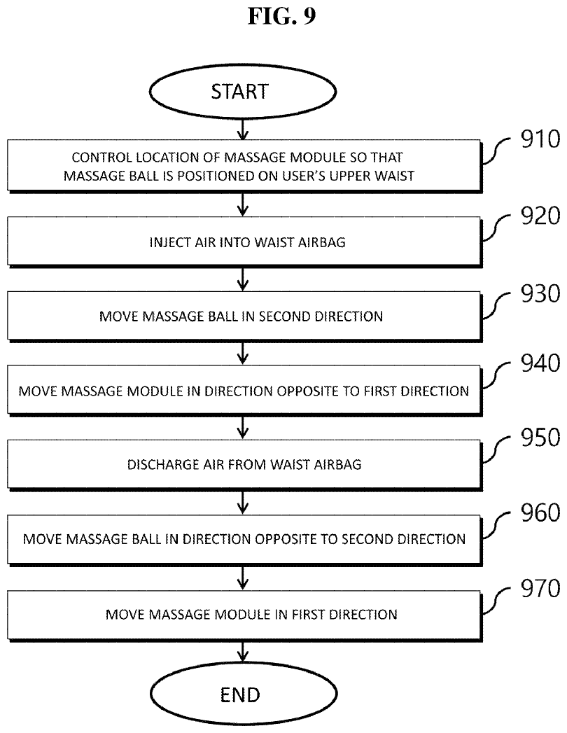

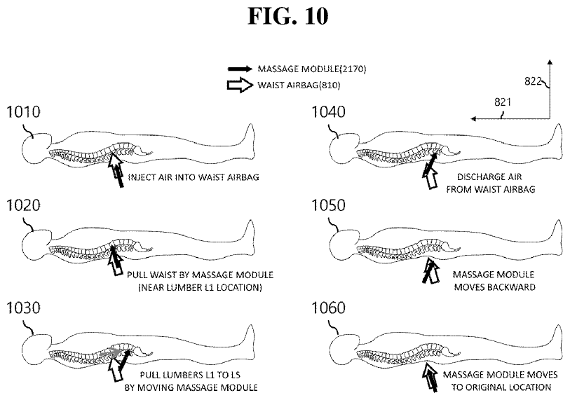

FIG. 9 is a flowchart for describing an operation of a massage apparatus according to an embodiment of the present disclosure. Further, FIG. 10 is a diagram for describing an operation of a massage apparatus according to an embodiment of the present disclosure.

The massage apparatus 100 may determine to pull the user's waist based on a user's input or a massage mode. The massage apparatus 100 may change a posture thereof so as to become a state to pull the waist before pulling the user's waist. More specifically, the control unit 300 may perform a step of controlling the back frame 2232 to recline backward with respect to the hip frame 2231. When the back frame 2232 is laid back with respect to the hip frame 2231, an angle between the user's legs and torso may increase. That is, the user may lie down comfortably. As such, when the user is completely lying down, the user may feel comfortable, and the waist airbag 810 and the massage ball may pull the user's waist. Additionally, the control unit 300 may perform a step of controlling the leg massage part 2300 to be lifted up. When the angle of the user's torso and the user's legs are not spread, pulling may be difficult because the user's waist spine is bent. When the leg massage part 2300 is lifted up, an angle between the user's calf and thigh may increase. That is, the user may lie down with his/her legs spread. Through this process, the massage apparatus 100 may be in the posture illustrated in FIG. 8.

The control unit 300 may perform step 910 of controlling the location of the massage module 2170 so that the massage ball included in the massage module 2170 is positioned on a user's upper waist. The massage module 2170 may need to be positioned at a starting location in order to pull the user's waist. The massage apparatus 100 may perform step 910 after moving the massage ball of the massage module 2170 in a direction opposite to the second direction. That is, the massage apparatus 100 may perform step 910 after moving the massage ball of the massage module 2170 away from the user. Accordingly, the massage apparatus 100 may prevent the massage module 2170 from pressurizing the user while the massage module 2170 is moving in step 910.

By step 910, the massage ball of the massage module 2170 may be positioned at lumbar L1 of the user. The massage module 2170 may locate the massage ball at lumbar L1, and start a waist pulling massage. That is, the location of the massage module 2170 when the massage ball is at lumbar L1 may be a starting location of the waist pulling massage.

Since each user has a different body shape, the massage apparatus 100 may determine the starting location of the massage module 2170 differently depending on the each user. The starting location may be determined based on, for example, the location of the user's shoulders. The starting location may be a location where the massage module 2170 is away from the location of the user's shoulders by a predetermined distance in a direction opposite to the first direction. The massage apparatus 100 may determine the starting location of the massage module 2170 differently through the following process.

The massage apparatus 100 may perform a step of determining a current location of the user's shoulders while moving the massage module 2170 from the top to the bottom of the body massage part 2100. The massage module 2170 may move from the top to the bottom along the rack gear of the main frame 2110 by an actuator. When the massage module 2170 moves from the top to the bottom and touches the user's shoulders, the load on a massage module movement actuator that moves the massage module 2170 up and down may increase. The massage apparatus 100 may determine the location of the user's shoulders based on the load of the massage module movement actuator. However, the present invention is not limited thereto, and the massage apparatus 100 may also determine a predetermined location as the location of the user's shoulders. Further, the massage apparatus 100 may determine the location of the user's shoulders differently based on the user's input. For example, the user may move the massage module up and down or down and up so that the massage ball of the massage module 2170 touches the user's shoulders. Further, the massage apparatus 100 may estimate the location of the user's shoulders based on a height or a sitting height of the user. For example, when the massage apparatus 100 stores a table in which the height or the sitting height of the user corresponds to the location of the user's shoulders, and the user inputs the height or sitting height, the massage apparatus 100 may obtain the location of the user's shoulders based on the table.

The massage apparatus 100 may obtain the current location of the massage module 2170 using an encoder included in the massage module movement actuator. The current location of the massage module 2170 may mean a location of the massage module 2170 on the rack gear of the main frame. The massage apparatus 100 may determine a value of the encoder as the location of the user's shoulders when the load of the massage module movement actuator increases.

The massage apparatus 100 may provide the massage to the user based on the determined location of the user's shoulders. For example, the massage module may determine that a neck portion is positioned above the location of the user's shoulders by a predetermined distance. Accordingly, the massage apparatus 100 may move the massage module 2170 above the determined location of the user's shoulders in order to massage a back of a neck of the user.

Additionally, the massage apparatus 100 may store a location of a seat in the memory. The massage apparatus 100 may divide an upper body length from the determined location of the user's shoulders to a lowermost end location of the back frame 2232 into n equal parts. For example, the massage apparatus 100 may determine a region from the lowermost end location of the back frame 2232 to a point k/n of the upper body length as the hip part. The massage apparatus 100 may determine, as the waist part, a region from a point k/n to a point (k+m)/n of the upper body length. Further, the massage apparatus 100 may determine, as the back part of the user, a region from a point (k+m)/n to a point (k+m+1)/n of the upper body length. Further, the massage apparatus 100 may determine, as the shoulder part of the user, a region from a point (k+m+1)/n of the upper body length to the location of the shoulders. The massage apparatus 100 may further divide the hip part, the waist part, the back part, and the shoulder part into h parts.

More specifically, the massage apparatus 100 may determine, as the waist part, aregion from a point k/n to a point (k+m)/n of the upper body length. Additionally, the massage apparatus 100 may divide the waist part into h parts. h may be 3. The waist part may include an upper waist part, a mid-waist part, and a lower waist part. For example, when the massage module 2170 is positioned in the upper waist part, the massage ball may be positioned near lumbar L1 of the user.

Here h, k, l, m, and n may be natural numbers. n may be larger than 1, m and k. Also, n may be larger than m+k+1. h may be 2 or more and 3 or less. The massage apparatus 100 may accurately move the massage module 2170 to the corresponding part based on massage part information included in the massage pattern.

Above, a configuration in which the massage ball of the massage module 2170 is positioned on a user's upper waist by step 910 has been described, but the configuration is not limited thereto. In step 910, the massage apparatus 100 may control the massage ball to be positioned on the user's middle or lower waist.

The massage apparatus 100 may perform step 920 of injecting air into the waist airbag. The massage apparatus 100 may be in the same state 1010 as in FIG. 10.

The massage apparatus 100 may perform step 930 of moving the massage ball in a second direction 822 so that the massage ball pressurizes the user. The massage apparatus 100 may be in the same state 1020 as in FIG. 10. As already described, the second direction 822 may be a direction from the back to the front of the user. The massage apparatus 100 may cause a massage ball 1130 to pressurize the user by moving the massage ball in the second direction 822. A location where the massage ball 1130 pressurizes the user may be near lumbar L1.

The massage apparatus 100 may perform step 940 of moving the massage module in a direction opposite to the first direction so that the massage ball is positioned on the user's lower waist. The massage apparatus 100 may be in the same state 1030 as in FIG. 10. The direction opposite to the first direction may be a direction from the head of the user to the hip of the user. The massage ball included in the massage module 2170 may move from the upper side of the user's waist to the lower side thereof while pressurizing the user's waist. More specifically, the massage ball may move from lumbar L1 to lumbar L5 while pressurizing the user. The user's lower back may refer to lumbar L5. Through such an operation of the massage module, the massage ball may pull the user's waist. Accordingly, the user's waist may be unfolded.

The massage apparatus 100 may further perform the following process when performing step 940 of moving the massage module in the direction opposite to the first direction so that the massage ball is positioned on the user's lower waist. The massage apparatus 100 may perform a step of controlling to lower the leg massage part 2300. In other words, the massage apparatus 100 may change from the state illustrated in FIG. 8 to the state illustrated on the right figure of FIG. 7. When changing the posture of the massage apparatus 100 as described above, the user's spine may be further unfolded and the user's spine may be pulled more effectively. In addition, step 950 of discharging air from the waist airbag, which will be described below, further includes a step of controlling to lift the leg massage part 2300, so that the leg massage part 2300 is again in the same state as in FIG. 8.

In step 940, a configuration for moving the massage module in the direction opposite to the first direction has been described, but the configuration is not limited thereto. When the massage ball of the massage module 2170 is positioned on the user's lower waist by step 910, the massage apparatus 100 may move the massage module 2170 in the first direction in step 940.

The massage apparatus 100 may perform step 950 of discharging air from the waist airbag 810. The massage apparatus 100 may be in the same state 1040 as in FIG. 10. That is, the waist airbag 810 may not support the user's waist. The user's waist may be supported by the massage ball of the massage module 2170. The massage ball of the massage module 2170 may support the user's lumbar L5.

The massage apparatus 100 may perform step 960 of moving the massage ball in a direction opposite to the second direction so that the massage ball does not pressurize the user. The massage apparatus 100 may be in the same state 1050 as in FIG. 10. Already described, the direction opposite to the second direction 822 may be the direction from the front to the back of the user. By step 960, the massage ball of the massage module 2170 may not pressurize the user.

The massage apparatus 100 may perform step 970 of moving the massage module in the first direction so that the massage ball is positioned on the upper waist from the lower waist. The massage apparatus 100 may be in the same state 1060 as in FIG. 10. The upper waist may refer to a location of lumber L1 of the user. When the massage module 2170 moves in the first direction, the massage ball may not pressurize the user's waist. By step 970, the massage ball of the massage module 2170 and the waist airbag 810 may be in the same state as in step 910. Steps 910 to 970 may be one cycle, and the massage apparatus 100 may perform one cycle at least once.

Step 910, where the control unit 300 controls the location of the massage module so that the massage ball is positioned on the user's upper waist, may further include the following process. The massage apparatus 100 may perform a step of injecting air into at least one airbag included in the leg massage part 2300 to fix the user's legs. When air is injected into at least one airbag included in the leg massage part 2300, a space between the user's legs and the leg massage part 2300 is filled by the at least one airbag included in the leg massage part 2300, so the user's legs may be fixed to the leg massage part 2300. Step 910 of moving the location of the massage module and injecting air into at least one airbag included in the leg massage part 2300 may be performed sequentially or simultaneously.

Further, the massage apparatus 100 may perform a step of injecting air into at least one airbag placed at both sides of the body massage part 2100 to fix the upper body of the user. At least one airbag placed at both sides of the body massage part 2100 may include at least one of a shoulder airbag 1220, a thigh airbag, and an armpit airbag. When at least one airbag placed at both sides of the body massage part 2100 is inflated, a space between the upper body of the user and the body massage part 2100 is filled, so that the upper body of the user may be fixed to the massage apparatus 100. Since the leg or the upper body of the user is fixed to the massage apparatus 100, the user may not be able to move forward as the waist airbag 810 or the massage module 2170 pressurizes the user. Therefore, an effect of waist pulling by the massage apparatus 100 may be increased. Step 910 of moving the location of the massage module and injecting air into at least one of the shoulder airbag 1220, the thigh airbag, and the armpit airbag may be performed sequentially or simultaneously.

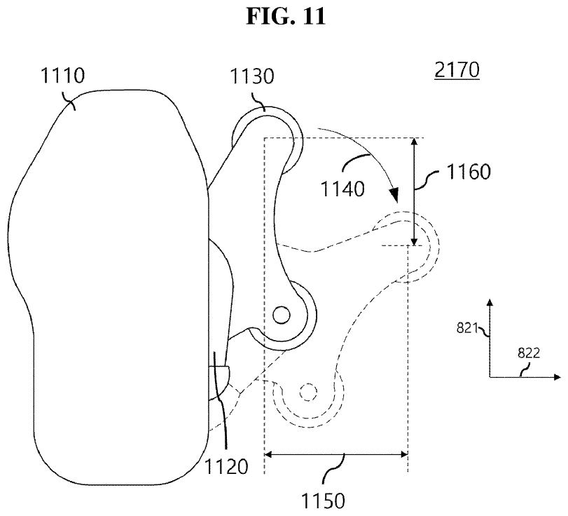

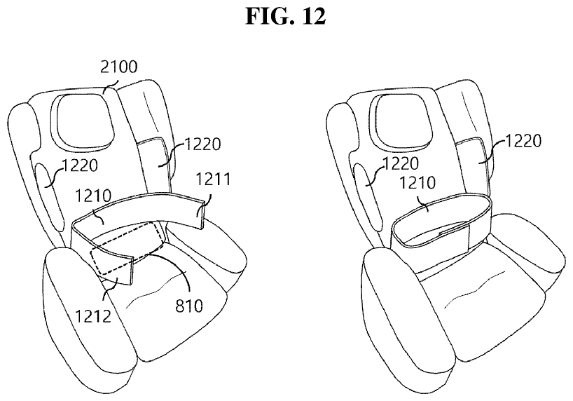

FIG. 11 is a diagram illustrating a massage module according to an embodiment of the present disclosure.

The massage module 2170 may include a module base frame 1110. The module base frame 1110 may form the framework of the massage module 2170. The massage module 2170 may include a massage ball rotation axis (not illustrated). The massage ball rotation axis may be coupled to the module base frame 1110 and extend left and right. Here, left and right may mean left and right sides when the user sits on the massage apparatus 100. The left and right directions may be perpendicular to a first direction 821 and a second direction 822.

The massage module 2170 may include a massage ball frame 1120 that rotates around the massage ball rotation axis. The massage ball frame 1120 may connect the base frame 1110 and the massage ball 1130. One end of the massage ball frame 1120 may be coupled to the massage ball rotation axis, and the other end of the massage ball frame 1120 may be coupled to the massage ball 1130.

The massage module 2170 may include the massage ball 1130. The massage ball 1130 may be connected to the other end of the massage ball frame 1120. The massage apparatus 100 may rotate the massage ball frame 1120 based on the massage ball rotation axis (1140) to move the massage ball in the second direction 822. Moving the massage ball by the massage apparatus 100 in the second direction 822 may mean rotating the massage ball frame 1120 (1140).

When the massage ball frame 1120 is rotated based on the massage ball rotation axis (1140), the massage ball 1130 may protrude in the second direction 822 by a first distance 1150 from an initial state of the massage ball 1130, and move in the direction opposite to the first direction 821 by a second distance 1160. The initial state of the massage ball 1130 may mean a state in which the massage ball 1130 moves as far as possible in the direction opposite to the second direction 822. A structure of the massage module 2170 illustrated in FIG. 11 may move the massage ball in the second direction 822 by the first distance 1150. The first distance may be 5 cm or more and 15 cm or less, and the second distance may be 5 cm or more and 10 cm or less. As the first distance is relatively large, the massage apparatus 100 has an effect of strongly pulling the user's spine, and the user's satisfaction may increase.

Moving the massage ball 1130 in the second direction 822 or in the direction opposite to the second direction 822 in steps 930 and 960 may mean rotating the massage ball frame 1120 around the massage ball rotation axis. That is, moving the massage ball 1130 in the second direction 822 in step 930 may mean rotating the massage ball frame 1120 around the massage ball rotation axis (1140). Moving the massage ball 1130 in the direction opposite to the second direction 822 in step 960 may mean rotating the massage ball frame 1120 around the massage ball rotation axis (opposite to 1140). At this time, in steps 930 and 960, while the massage module 2170 stops with respect to the main frame 2110, only the massage ball 1130 may be moved.

FIG. 12 is a diagram for describing an upper body fixing unit according to an embodiment of the present disclosure.

The massage apparatus 100 may include an upper body fixing unit 1210 for fixing the upper body of the user. The upper body fixing unit 1210 may be coupled to the cover of the body massage part 2100. The upper body fixing unit 1210 is positioned in the first direction 821 from the waist airbag 810, and may have a belt shape extending left and right. The waist airbag 810 being positioned in the first direction 821 may mean that the upper body fixing unit 1210 is closer to the head of the user than the waist airbag 810. A material of the upper body fixing unit 1210 may be the same as that of the cover of the body massage part 2100.

The upper body fixing unit 1210 may have a first coupling part formed on one surface of one side 1211 and a second coupling part formed on the other surface of the other side 1212. The first coupling part and the second coupling part are coupled to each other to surround the upper body of the user. Accordingly, by combining the first coupling part and the second coupling part, the upper body of the user may be fixed to the body massage part 2100.

The control unit 300 may perform a step of checking whether the first coupling part is coupled to the second coupling part based on a signal from a sensor unit. The sensor unit may be a contact sensor that detects whether the first coupling part and the second coupling part are in contact. The contact sensor may include at least one of a microswitch, a hall sensor, a photoelectric sensor, an inductive proximity switch, a capacitive proximity switch, and a reed switch. The sensor unit may transmit whether the coupling is performed to the control unit 300.

When the first coupling part is coupled to the second coupling part, the control unit 300 may perform either step 910 of controlling the location of the massage module so that the massage ball is positioned on the user's upper waist or step 920 of injecting air into the waist airbag 810. That is, when it is confirmed that the upper body of the user is fixed, the massage apparatus 100 may pull the spine of the user. As such, by pulling the spine of the user after the upper body of the user is fixed, the effect of spine pulling may be increased.

The massage apparatus 100 may output whether the first coupling part and the second coupling part are coupled through the output unit. Therefore, the user may check whether the first coupling part and the second coupling part are coupled. Additionally, the user may notice that the user forgets to couple the first coupling part and the second coupling part, and may couple the first coupling part and the second coupling part.

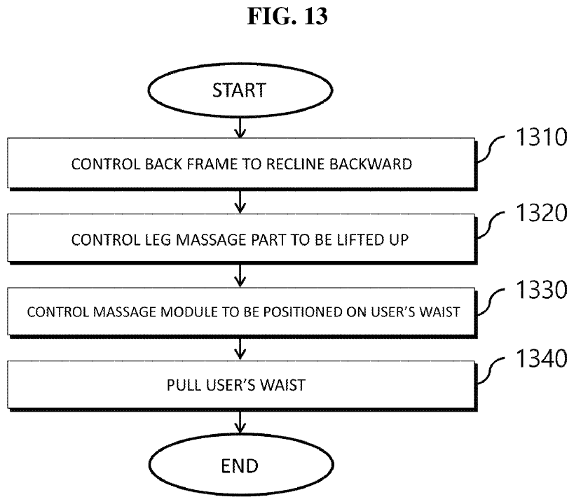

FIG. 13 is a flowchart for describing an operation of a massage apparatus according to another embodiment of the present disclosure.

The massage apparatus 100 may bring the posture of the massage apparatus 100 to the state illustrated in FIG. 8 before providing spinal pulling. The control unit 300 may perform step 1310 of controlling the back frame 2232 to recline backward with respect to the hip frame 2231. Additionally, the control unit 300 may perform step 1320 of controlling the leg massage part 2300 to be lifted up. Additionally, the massage apparatus 100 may perform step 1330 of controlling the location of the massage module 2170 so that the massage ball 1130 or the massage module 2170 is positioned on the user's waist. By step 1330, the massage module 2170 may be positioned at one of the upper, middle, and lower sides of the user's waist.

Steps 1310, 1320, and 1330 may be performed sequentially or simultaneously.

After the posture of the massage apparatus 100 is changed as illustrated in FIG. 8 through the above process, the massage apparatus 100 may perform step 1340 of pulling the user's waist based on the massage ball and the waist airbag. More specifically, the massage apparatus 100 may pull the user's waist while moving the massage balls in at least one of a first direction, a second direction, a direction opposite to the first direction, and a direction opposite to the second direction. Additionally, the massage apparatus 100 may pull the user's waist while injecting air into the waist airbag or discharging air from the airbag.

The control unit 300 may perform a step of checking whether the first coupling part is coupled to the second coupling part based on the signal from the sensor unit. Additionally, when the first coupling part is coupled to the second coupling part, the control unit 300 may perform step 1340 of pulling the user's waist based on the massage ball 1130 and the waist airbag 810. That is, when it is confirmed that the upper body of the user is fixed, the massage apparatus 100 may pull the spine of the user. As such, by pulling the spine of the user after the upper body of the user is fixed, the effect of spine pulling may be increased.

Step 1330 in which the control unit 300 controls the location of the massage module 2170 so that the massage ball is positioned on the user's waist may further include the following process. The leg massage part 2300 may include at least one airbag for pressurizing the user's legs. The massage apparatus 100 may perform a step of injecting air into at least one airbag included in the leg massage part 2300 to fix the user's legs. When air is injected into at least one airbag included in the leg massage part 2300, a space between the user's legs and the leg massage part 2300 is filled by the at least one airbag included in the leg massage part 2300, so the user's legs may be fixed to the leg massage part 2300.

Further, the body massage part 2100 may include at least one airbag for pressurizing the torso of the user. The massage apparatus 100 may perform a step of injecting air into at least one airbag placed at both sides of the body massage part 2100 to fix the upper body of the user. At least one airbag placed at both sides of the body massage part 2100 may include at least one of a shoulder airbag 1220, a thigh airbag, and an armpit airbag. When at least one airbag placed at both sides of the body massage part 2100 is inflated, a space between the upper body of the user and the body massage part 2100 is filled, so that the upper body of the user may be fixed to the massage apparatus 100.

Step 1330 of moving the position of the massage module and the step of inflating at least one of the airbag included in the leg massage part 2300, the shoulder airbag 1220, the thigh airbag, and the armpit airbag may be performed sequentially or simultaneously.

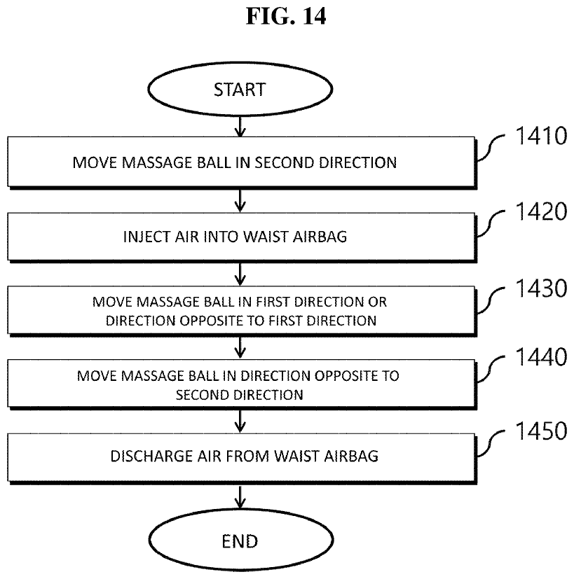

FIG. 14 is a flowchart for describing an operation of a massage apparatus according to another embodiment of the present disclosure.

Step 1340 in which the massage apparatus 100 pulls the user's waist may include the following process. The massage apparatus 100 may perform step 1410 of moving the massage ball in the second direction 822. By step 1410, the massage ball may pressurize the user's waist.

The massage apparatus 100 may perform step 1420 of injecting air into the waist airbag 810 simultaneously with, immediately before, or immediately after the step of moving the massage ball in the second direction 822. The massage apparatus 100 injects air into the waist airbag 810 so that the waist airbag 810 may pull or support the user's waist.

The massage apparatus 100 may perform step 1430 of moving the massage ball in the first direction 821 or the direction opposite to the first direction 821. Through this, the spine of the user may be pulled. Additionally, the massage ball may pull the user's waist while moving from the bottom to the top or from the top to the bottom of the user's waist. That is, if the massage ball is initially at the user's lower waist, the massage ball may move in the first direction 821 while performing acupressure on the user's waist. Further, if the massage ball is initially at the user's upper waist, the massage ball may move in the direction opposite to the first direction while performing the acupressure on the user's waist.

The massage apparatus 100 may perform step 1440 of moving the massage ball in the direction opposite to the second direction 822. Therefore, the massage ball may no longer pull the user's waist. The massage apparatus 100 may perform the step of discharging air from the waist airbag 810 simultaneously with, immediately before, or immediately after the step of moving the massage ball in the direction opposite to the second direction 822. Accordingly, the waist airbag 810 may no longer support or compress the user's waist.

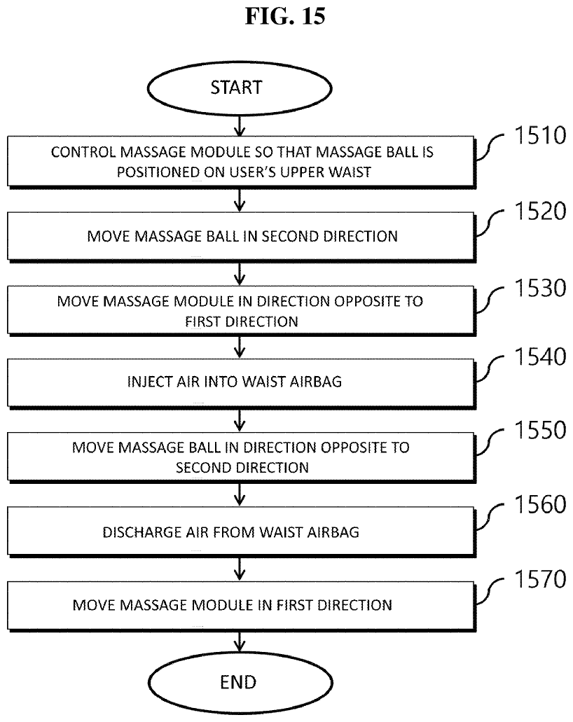

Each step of FIG. 14 may be embodied as the steps of FIG. 9 or the steps of FIG. 15. Since FIG. 9 has already been described, FIG. 15 will be described in more detail below.

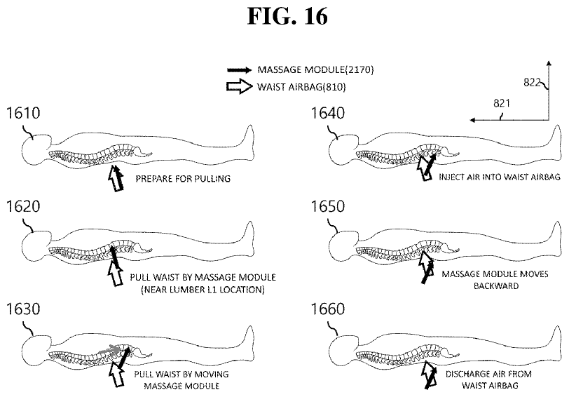

FIG. 15 is a flowchart for describing an operation of a massage apparatus according to another embodiment of the present disclosure. Further, FIG. 16 is a diagram for describing an operation of a massage apparatus according to another embodiment of the present disclosure.

Since the operation of the massage apparatus 100 has been sufficiently described above, hereinafter, parts that are different from the existing parts will be described and redundant explanations will be omitted.

Step 1330 of controlling the location of the massage module may include the following processes. The massage apparatus 100 may perform step 1510 of controlling the location of the massage module so that the massage ball is positioned on the user's upper waist. Step 1510 may correspond to step 910. By step 1510, the massage apparatus 100 may be in the same state 1610 as in FIG. 16.

Step 1340 of pulling the user's waist may include the following process. The massage apparatus 100 may perform step 1520 of moving the massage ball in the second direction so that the massage ball pressurizes the user. By step 1520, the massage apparatus 100 may be in the same state 1620 as in FIG. 16.

The massage apparatus 100 may perform step 1530 of moving the massage module 2170 in the direction opposite to the first direction so that the massage ball is positioned on the user's lower waist. By step 1530, the massage apparatus 100 may be in the same state 1630 as in FIG. 16. Due to such movement of the massage module, the massage ball may pull the user's waist. Since the massage ball pressurizes the user's waist without air being injected into the waist airbag 810, the massage apparatus may intensively apply pressure to a local part of the user. Users who like finger acupressure massage may feel satisfied.

The massage apparatus 100 may further perform the following process when performing step 1530 of moving the massage module in the direction opposite to the first direction so that the massage ball is positioned on the user's lower waist. The massage apparatus 100 may perform a step of controlling to lower the leg massage part 2300. In other words, the massage apparatus 100 may change from the state illustrated in FIG. 8 to the state illustrated on the right figure of FIG. 7. When changing the posture of the massage apparatus 100 as described above, the user's spine may be further unfolded and the user's spine may be pulled more effectively. In addition, step 1540 of injecting air into the waist airbag or step S1560 of discharging air from the waist airbag, which will be described below, further includes a step of controlling to lift the leg massage part 2300, so that the leg massage part 2300 is again in the same state as in FIG. 8.

The massage apparatus 100 may perform step 1540 of injecting air into the waist airbag 810. By step 1540, the massage apparatus 100 may be in the same state 1640 as in FIG. 16. The waist airbag 810 may support the user's waist. Further, the waist airbag 810 may pull the spine of the user.

The massage apparatus 100 may perform step 1550 of moving the massage ball in the direction opposite to the second direction 822 so that the massage ball does not pressurize the user. By step 1550, the massage apparatus 100 may be in the same state 1650 as in FIG. 16.

Accordingly, the waist airbag 810 may support the user's waist.

The massage apparatus 100 may perform step 1560 of discharging air from the waist airbag. By step 1560, the massage apparatus 100 may be in the same state 1660 as in FIG. 16.

The massage apparatus 100 may perform step 1570 of moving the massage module in the first direction 821 so that the massage ball 1130 is positioned on the user's upper waist. By step 1570, the massage apparatus 100 may be in the same state 1610 as in FIG. 16. Steps 1510 to 1570 may be one cycle, and the massage apparatus 100 may perform one cycle at least once.

In steps 910 and 1510, the massage apparatus 100 controls the massage ball to be positioned on the user's upper waist, but is not limited thereto.

Steps 910 and 1510 in which the massage apparatus 100 controls the position of the massage module may include a step of controlling the location of the massage module 2170 so that the massage ball 1130 is positioned on the user's lower waist. That is, the starting location of the massage module 2170 may be the user's lower waist. The lower waist may refer to a location of lumber L5 of the user.

When performing step 1340 of pulling the user's waist, the massage apparatus 100 may perform the following process. The massage apparatus 100 may perform the step of injecting air into the waist airbag. Further, the massage apparatus 100 may perform the step of moving the massage ball in the second direction so that the massage ball pressurizes the user. The massage apparatus 100 may perform the step of moving the massage module in the first direction so that the massage ball is positioned on the user's upper waist. The massage apparatus 100 may perform the step of discharging air from the waist airbag. The massage apparatus 100 may perform the step of moving the massage ball in the direction opposite to the second direction so that the massage ball does not pressurize the user. The massage apparatus 100 may perform the step of moving the massage module in the direction opposite to the first direction so that the massage ball is positioned on the lower waist. The massage apparatus 100 may complete one cycle in this way. The massage apparatus 100 may repeat one cycle at least once.

As above, the massage apparatus 100 may pull the spine of the user. Compared to the existing massage apparatus, the massage apparatus 100 of the present disclosure may move the massage ball of the massage module 2170 significantly toward the user, thereby more effectively pulling the spine of the user. Additionally, the massage apparatus 100 may effectively pull the spine of the user through the processes illustrated in FIGS. 9 and 13 to 15. The user may feel as if a person is pulling the spine of the user.

So far, various embodiments have been primarily described. It is understood to those skilled in the art to which the present invention pertains that the present invention may be implemented as a modified form without departing from an essential characteristic of the present invention. Therefore, the disclosed embodiments should be considered in an illustrative viewpoint rather than a restrictive viewpoint. The scope of the present invention is defined by the appended claims rather than by the foregoing description, and all differences within the scope of equivalents thereof should be construed as being included in the present invention.

Meanwhile, the embodiments of the present invention described above may be prepared by a computer executable program and implemented by a general purpose digital computer which operates the program by using a computer readable recording medium. The computer readable recording medium includes storage media such as magnetic storage media (e.g., a ROM, a floppy disk, a hard disk, and the like) and optical reading media (e.g., a CD-ROM, a DVD, and the like).

1. A method for operating a massage apparatus, comprising:
controlling, by a control unit, a back frame to recline backward with respect to a hip frame so that a user becomes a lying posture;
controlling, by the control unit, a leg massage part to be lifted up;
controlling a location of a massage module which is movable along the back frame and the hip frame so that a massage ball is positioned on a user's waist; and
pulling the user's waist by moving the massage ball in at least one of a first direction and a second direction, and injecting air into a waist airbag,
wherein the first direction as a direction parallel to a longitudinal direction of an upper frame is a direction from a hip to a head of the user, and
the second direction as a direction perpendicular to the longitudinal direction of the upper frame is a direction from a back to a front of the user.

2. The method for operating a massage apparatus of claim 1, wherein the pulling of the user's waist includes
moving the massage ball in the second direction;
injecting air into the waist airbag simultaneously with, immediately before, or immediately after the moving of the massage ball in the second direction;
moving the massage ball in the first direction or a direction opposite to the first direction;
moving the massage ball in a direction opposite to the second direction; and
discharging air from the waist airbag simultaneously with, immediately before, or immediately after the moving of the massage ball in the direction opposite to the second direction.

3. The method for operating a massage apparatus of claim 1, wherein the pulling of the user's waist includes
controlling, by the control unit, the location of the massage module so that the massage ball is positioned on a user's upper waist;
injecting air into the waist airbag;
moving the massage ball in the second direction so that the massage ball pressurizes the user;
moving the massage module in the direction opposite to the first direction so that the massage ball is positioned on a user's lower waist;
discharging air from the waist airbag;
moving the massage ball in the direction opposite to the second direction so that the massage ball does not pressurize the user; and
moving the massage module in the first direction so that the massage ball is positioned on the user's upper waist.

4. The method for operating a massage apparatus of claim 3, wherein the controlling of the location of the massage module by the control unit so that the massage ball is positioned on the user's upper waist includes
controlling the back frame to recline backward, and controlling, by the control unit, the leg massage part to be lifted up.

5. The method for operating a massage apparatus of claim 4, wherein the massage apparatus for pulling a spine includes a body massage part, the leg massage part, and the control unit controlling an operation of the massage apparatus, and
the body massage part includes
a main frame including a base frame, the upper frame, and a lower frame,
a massage module including the massage ball which is movable in the first direction or the direction opposite to the first direction along the upper frame, and movable in the second direction or the direction opposite to the second direction, and providing a massage to the user, and
the waist airbag placed adjacent to a frame rotation axis between the back frame and the hip frame included in the upper frame, and pulling the user's waist.

6. The method for operating a massage apparatus of claim 5, wherein the controlling of the location of the massage module by the control unit so that the massage ball is positioned on the user's upper waist includes
injecting air into at least one airbag included in the leg massage part in order to fix user's legs; and
injecting air into the at least one airbag placed at both sides of the body massage part in order to fix an upper body of the user.

7. The method for operating a massage apparatus of claim 5, wherein the massage apparatus includes an upper body fixing unit coupled to a cover of the body massage part, and positioned in the first direction from the waist airbag and having a belt shape extending left and right; and
the upper body fixing unit has a first coupling part formed on one surface of one side and a second coupling part formed on the other surface of the other side, and the first coupling part and the second coupling part are coupled to fix the upper body of the user.

8. The method for operating a massage apparatus of claim 7, comprising:
checking, by the control unit, whether the first coupling part is coupled to the second coupling part based on a signal of a sensor unit; and
controlling, by the control unit, the location of the massage module so that the massage ball is positioned on the user's upper waist when the first coupling part is coupled to the second coupling part,
wherein the sensor unit is a contact sensor sensing whether the first coupling part and the second coupling part are in contact with each other.

9. The method for operating a massage apparatus of claim 3, wherein the moving of the massage module in the direction opposite to the first direction so that the massage ball is positioned on the user's lower waist includes
controlling the leg massage part to be lowered, and
the discharging of air from the waist airbag includes
controlling the leg massage part to be lifted up.

10. The method for operating a massage apparatus of claim 5, wherein the massage module includes
a module base frame forming a framework of the massage module;
a massage ball rotation axis coupled to the module base frame and extending left and right;
a massage ball frame rotating based on the massage ball rotation axis; and
the massage ball connected to the massage ball frame, and
when the massage ball frame is rotated based on the massage ball rotation axis, the massage ball protrudes in the second direction by a first distance, and moves in the direction opposite to the first direction by a second distance from an initial state of the massage ball, and
the first distance is 5 cm or more and 15 cm or less, and the second distance is 5 cm or more and 10 cm or less.
